(19) United States
(12) Patent Application Publication
(10) Pub. No.: US 2011/0069690 A1
(43) Pub. Date: Mar. 24, 2011

(54) METHOD, SYSTEM, AND COMPUTER-READABLE MEDIUM FOR THE PROTECTION OF AD-HOC WIRELESS DEVICE OPERATION

(76) Inventor: Jesse Caulfield, McLean, VA (US)

(21) Appl. No.: 12/887,482

(22) Filed: Sep. 21, 2010

Related U.S. Application Data
(60) Provisional application No. 61/244,439, filed on Sep. 21, 2009.

(51) Int. Cl. H04W 4/00

(52) U.S. Cl. 370/338

(57) ABSTRACT

In an embodiment of the invention, a system may include one or more wireless transmitters and a transportable transmitter having at least one processor and at least one storage device. The transportable transmitter may be configured to communicate with the one or more wireless transmitters, store operational data in the storage device, encapsulate the operational data into a message, and transmit the message to establish a geographic protected contour for the wireless transmitter. The wireless transportable transmitter may, after transmitting the message, transmit information from within the geographic protected contour to a receiver outside the geographic protected contour while receiving interference protection on the transmitting frequency within the geographic contour.

This application claims the benefit of U.S. Provisional Application No. 61/244,439, filed Sep. 21, 2009. The above referenced application is hereby incorporated by reference in its entirety.

### BACKGROUND

1. Field of Invention

This invention relates to communication systems and, more particularly, to the calculation and communication of frequency occupancy and interference avoidance between subscribing radio systems.

2. Description of the Related Art

Radio frequency transmitters may operate as primary and secondary spectrum users (e.g., spectrum may include, but is not limited to frequencies allocated for television (TV), AM/FM radio, mobile satellite, land mobile radio, etc.). Not all secondary spectrum uses are equal however, and a hierarchy of secondary applications may be established where certain secondary transmitters and receivers have precedence. For example, but not limited to, the VHF and UHF frequency bands support wireless microphones, medical telemetry devices and broadcast auxiliary links that may be considered secondary transmitters that may not cause interference with primary transmitters (e.g. broadcast television).

### SUMMARY OF THE INVENTION

One embodiment of the invention may include a computer-readable medium which may include processor executable instructions. The processor executable instructions may be for collecting remote location operational data by a transportable transmitter, encapsulating the operational data into a message by the transportable transmitter, transmitting from the transportable transmitter the message to request a geographic protect contour for the transportable transmitter. The processor executable instructions may be for receiving by the transportable transmitter at least one of a first acknowledgement of a complete resource reservation request for the geographic protected contour, or a second acknowledgement of the establishment of the geographic protected contour.

In another embodiment of the invention, a computer-implemented method to reduce interference around wireless transmitters may include generating a message to request a geographic protective contour by a requestor device having at least one processor, transmitting the message from the requestor device via a network, and transmitting within the geographic protective contour by the requestor device.

In yet another embodiment, a system may include one or more transmitters and a transportable transmitter having at least one processor and at least one storage device. The transportable transmitter may be configured to communicate with the one or more transmitters, store operational data in the storage device, encapsulate the operational data into a message, and transmit the message to establish a geographic protected contour for the transportable transmitter. The transportable transmitter may, after transmitting the message, transmit information on a transmitting frequency from within the geographic protected contour while receiving interference protection on the transmitting frequency within the geographic contour.

### BRIEF DESCRIPTION OF THE DRAWINGS

FIG. 1 illustrates an example system block diagram showing a radio frequency environment configured to practice an exemplary embodiment;

FIG. 2 illustrates an example high level operational flow chart 200 describing the steps to establish interference avoidance with ad-hoc creation of geographic protected contours according to an exemplary embodiment;

FIG. 3 depicts an example logical system chart 300 illustrating the types of information that may be gathered and how that information may be assembled and exchanged from, for example, an ad-hoc location 130 to an established location 120 and then to a radio resource coordinator 107 to establish ad-hoc interference protection via a newly created geographic contour 104 according to an exemplary embodiment;

FIG. 4 depicts an example logical system chart 400 illustrating the types of information that may be gathered and how that information may be assembled and exchanged from, for example, an ad-hoc location 130 directly to a radio resource coordinator 107 to establish ad-hoc interference protection via a newly created geographic contour 104 according to an exemplary embodiment; and

FIG. 5 illustrates an example computer system 500 that may be configured to practice an exemplary embodiment.

### DETAILED DESCRIPTION

### Overview

Some types of secondary transmitters may have precedence over, and may be entitled to interference protection from, other secondary transmitters (e.g. unlicensed devices, experimental transmitters).

To provide for the interference protection of primary transmitters (e.g., but not limited to, broadcast television, land mobile radio, etc.) from secondary wireless transmitters (e.g., but not limited to, wireless microphones, medical telemetry devices, mobile phones, personal computers, etc.) and of privileged secondary transmitters from other secondary transmitters, transmitters may employ any number or combination of methods including, but not limited to, spectrum sensing, consultation with a resource coordinator, and geo-location to identify the presence of geographic protected contours. A radio resource coordinator may establish the boundaries of geographic protected contours based on information submitted to it by transmitters seeking protection from interference. Information submitted may constitute a request for protection, and to be accepted such requests may require the inclusion of certain information about the requestor such as, for example, but not limited to the name and contact details of the requesting party, contact information for the responsible transmitter operator, other details including, for example, the make, model and serial number of transmitting equipment, the frequencies to be protected, the time and duration of protected operation, etc. A resource coordinator may require that some or all information in an interference protection request be present prior to establishing the requested geographic protected contour.

When using geographic protected contours as a method of interference avoidance, a secondary transmitter, for example, should not radiate on the same frequencies of a primary or “privileged secondary” transmitter if it is physically located within a geographic contour established by a radio coordinator around a protected transmitter. Conversely, if the secondary transmitter is physically located outside the described contour then those frequencies may be considered available for use.

Examples of privileged secondary use entitled to interference protection include transportable broadcast television news services, where reporters employing wireless microphones and video recording equipment must quickly relocate to, and establish, for example, wireless microphone and video transmissions at locations that cannot be planned or scheduled in advance; like the scene of an accident, for example.

In news gathering and similar scenarios the likelihood of receiving interference from other, lesser-privileged transmitters may increase if those other transmitters are not aware of, or are unable to detect and avoid, for example, the nearby protected transmissions.

Thus, as discovered by the inventor, there is a need for radio resource coordinator techniques that may rapidly establish interference protection for privileged transmitters that require ad-hoc wireless transmissions. Ad-hoc may mean temporary but may also include unplanned but semi-permanent.

An embodiment of this invention may enable a wireless transmitter (e.g., but not limited to, wireless microphone, land mobile radio system, medical telemetry device, etc.) to rapidly communicate various credentials and its present geographic location. This may be useful, for example, in establishing a privileged secondary transmitter registration with a radio resource coordinator. The technique may involve the establishment of a trust relationship between, for example, a transmitter's (e.g., but not limited to wireless microphone, mobile phone, medical telemetry device, etc.) responsible party (e.g. but not limited to owner, license holder, operator, technician, etc.) and the radio resource coordinator. Certain information may be exchanged and pre-verified between parties prior to registration, allowing, for example, a streamlined and more automated and thus more rapid registration and implementation process.

### Example Embodiments

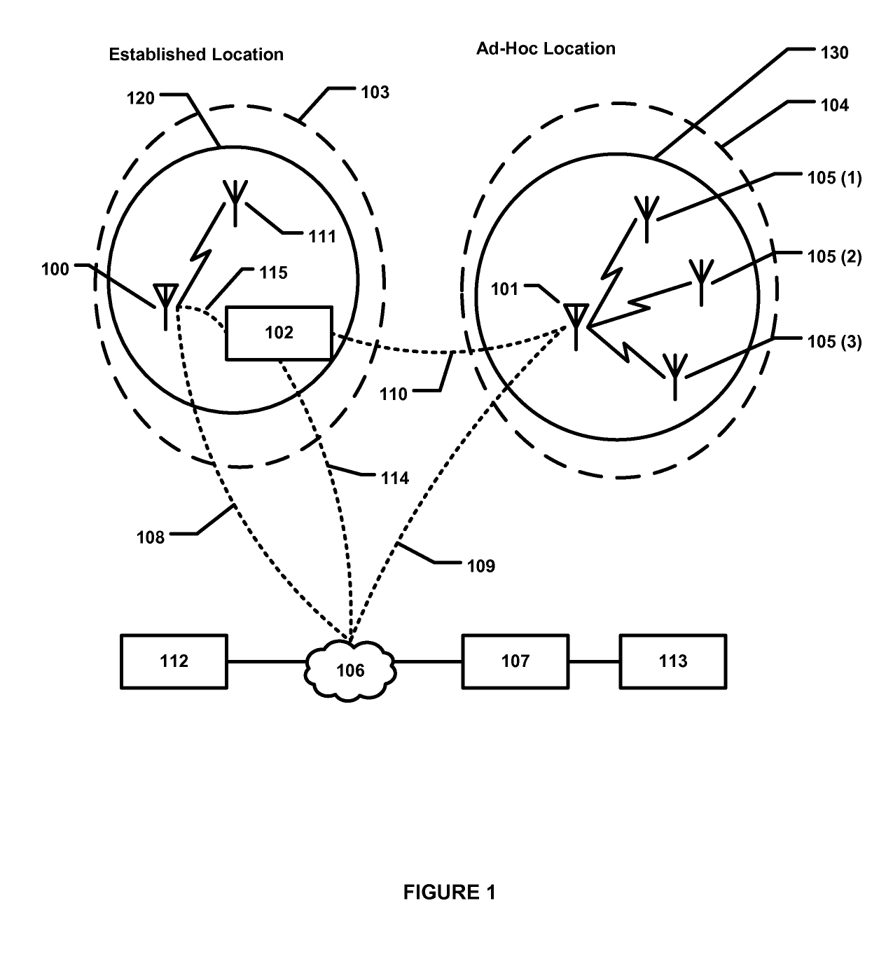

FIG. 1 illustrates an example system block diagram showing a radio frequency environment configured to practice an exemplary embodiment. In the embodiment of FIG. 1, an established location 120 (e.g. but not limited to a theater, movie sound stage, television broadcast studio, etc.) establishes wireless transmissions (e.g., but not limited to wireless microphone, one or two-way data network, etc.) from a fixed (e.g., but not limited to, permanently installed, transportable, etc.) transmitter 100. The fixed transmitter 100 may automatically communicate its location and transmitting parameters (e.g. but not limited to frequency, power, modulation, minimum acceptable signal to noise ratio, etc.) via a digital communications network 108 (e.g., but not limited to the Internet) to a radio resource coordinator 107 (e.g., but not limited to, a computer system with access to a database of transmitters). Alternatively, fixed transmitter 100 may communicate its location and transmitting parameters to a proxy computer system 102, via the communications network 115 (e.g., but not limited to, a local area network, the Internet, etc.). The proxy computer system 102 may add additional information to the communication prior to relaying the communication to the coordinator 107 via a communications network 114 (e.g., but not limited to, the Internet). The coordinator 107 may establish a geographic protected contour 103 based on the communicated information. The geographic protected contour 103 may be a designated area where a frequency (or frequencies, frequency band(s), channel(s), spectrum, etc.) may be reserved for the exclusive use of the fixed transmitter 100. Fixed transmitter 100 may also represent many transmitters and receivers 111. By this method, interference protection from other secondary, possibly unlicensed, transmitters is established within the defined geographic protected contour enclosing the established location, e.g., the transmitters and receivers 100 and 111.

In another embodiment, a transportable (e.g. portable but not mobile) transmitter 101 may be located at a remote site of interest. The transportable transmitter 101 may establish wireless communication with transmitters 105(1), 105(2), 105(3), collectively referred to as 105. As example, the transmitter 105 may represent wireless microphones, personal computers, digital or analog radios, etc. FIG. 1 depicts transportable transmitter 101 as being set up at a remote location 130 (e.g., but not limited to, a sports arena, a conference room, a theater, an accident scene, etc.) for providing, for example, sports reporting, data networking, a theater production or news reporting.

The transportable transmitter 101 may automatically register itself with the coordinator 107 and may thereby establish, on-demand, a new geographically protected services contour 104 for ad-hoc transmissions. The transportable transmitter 101 may communicate to the coordinator 107 through a communications link 110 (e.g., but not limited to, satellite, microwave, Wi-Max, Wi-Fi, etc.), which may connect transportable transmitter 101 to a proxy computer system 102, and through the communication link 114 between proxy computer system 102 and another network 106 (e.g., but not limited to, the Internet). Alternatively, transportable transmitter 101 may communicate directly with the coordinator 107 using a communication link 109 (e.g., but not limited to, satellite, microwave, Wi-Max, Wi-Fi, etc.), which may connect transportable transmitter 101 and a network 106 (e.g., but not limited to, the Internet), depending upon its capabilities and configuration.

In another embodiment, coordinator 107 may establish a geographic protected contour (e.g., but not limited to 103 or 104) using a minimum set of valid, current and correct information which may be maintained, for example, by a user or designated party (e.g. technician, lawyer, etc.). This information may be sent from the transportable transmitter 101, the fixed transmitter 100, or via the proxy computer system 102. Prior to sending the information, the information may be encapsulated into an authenticated and encrypted message. This information may include, for example:
Name and/or address of the individual or business that owns or maintains the transmitting devices;
The address, phone number and/or the email address of a contact person;
The geographic coordinates where the transmitting device may be used;
The frequencies to be used;
The time and duration of operation;
Payment information (e.g., but not limited to, billing name and address, credit card information, billing number, etc.); and/or
Equipment information (e.g., but not limited to, type, model number, serial number, max/min power, spectrum range, etc.).

In an exemplary embodiment, a reduced amount of information may be communicated for the establishment of a geographic protected services contour. For example, the radio resource coordinator may be configured to accept a cryptographic certificate, geographic coordinates, and/or the desired frequencies as enough information to establish a geographic protected contour.

The process a transmitter 100, 101 may follow when communicating with the resource coordinator 107 may be automated by collecting, in advance, any required information, which may be assembled, for example, by computer using an algorithm at the time of the request by the transmitter 100, 101 for geographic protection by coordinator 107. Information collection may occur via a web portal 112 (designed for the registration of users and equipment plus maintenance of records), manual entry, machine-readable message (e.g., but not limited to, XML, SOAP, etc.), or other method and may be stored by the coordinator 107 for later retrieval in a database 113 (e.g., but not limited to, a records in a relational database, data on a file system or other information storage technique). The database 113 may be separate from or part of the coordinator 107.

Transportable transmitter 101 may send a signal to an established location 120 via a communications link 110 (e.g. but not limited to satellite, microwave, WiMax, etc.) which may also transport communications, such as, data, voice and video. Transportable transmitter 101 and/or transmitters 105 may communicate operational information to, for example, a proxy computer system 102 at the established location 120 including, for example, one or more of its geographic location, the identification of transmitters 105, the type of wireless communication between transmitters, operating frequencies and other transmission parameters. The proxy computer system 102 may add other information (e.g., but not limited to, authenticating digital certificates, responsible party name, payment information, etc.) to create a complete and fully qualified resource reservation and then forward this via a digital communications network 106 (e.g., but not limited to, the Internet) to coordinator 107. The resource reservation may be the information required to establish a geographic contour. In another embodiment, the proxy computer system 102 may not be used, and information may be sent directly from transportable transmitter 101 and/or transmitters 105 to coordinator 107 via communications link 109.

The coordinator 107 may positively identify the sending party or requestor device (e.g., fixed transmitter 100, transportable transmitter 101, proxy computer system 102, transmitters 105, etc.) through an encryption profile. For example, each system and device may be configured with a public/private key pair and a public key infrastructure system may be used. The coordinator 107 or the fixed transmitter 100 may identify, for example, the transportable transmitter 101, or transmitters 105, through encryption and/or authentication schemes. For example, when requesting a geographically protected contour 104, the transportable transmitter 101, or transmitters 105, may sign their communication (e.g., but not limited to, a message) with their unique digital signature. When the communication is received by the coordinator 107, for example, the sender of the request may be identified using, for example, the digital signature.

The coordinator 107 may also establish through its internal configuration or database 113 whether the sending party is authorized to establish a protected services contour and the geographic extent of such authorization. For example, when the coordinator 107 receives an incomplete request to establish a geographic contour, it may retrieve the missing required information using the digital signature as an identifying key to find the information. Information may be retrieved from a database 113, for example, accessible by the coordinator 107. The information retrieved may be, for example, a pre-configured user profile containing all the required information except that which was submitted in the request. In an exemplary embodiment, enough information to create a geographically protected contour may be already accessible by the coordinator 107 (e.g., but not limited to records in a database). In that case, the signed request may provide enough information to create a geographically protected contour 103, 104.

If a requesting transmitter 101 is authorized, the coordinator 107 may automatically create a resource reservation record establishing a geographic protected contour 104 around the requestor device, e.g., the transportable transmitter 101 and/or the transmitters it serves 105. In one embodiment, once the coordinator 107 creates a valid resource reservation record and establishes a geographically protected contour 104, the coordinator 107 may send message data to the requestor device, (e.g., but not limited to, transportable transmitter 101) acknowledging the reservation and/or describing the geographically protected contour 104. In another embodiment, no acknowledgment is required to be sent from the coordinator 107 to the requestor device.

In another embodiment, a request for an ad-hoc protected contour 104 may be sent from a requestor (e.g., from transmitter 105 or transportable transmitter 101) without an operating frequency identified. The coordinator 107 may choose a frequency and automatically establish a geographically protected contour 104 and may send data to the requestor indicating the assigned frequency.

In another embodiment, a frequency request and/or a request for a geographically protected contour 104, without a frequency selected, may be sent from a requestor (e.g., from transmitter 105 or transportable transmitter 101). The coordinator 107 may send data to the requestor indicating a list of possible frequencies without making a frequency assignment or creating a protected contour. The requestor may then request a geographic protected contour e.g., 103, 104 on a frequency (or frequencies, frequency band(s), spectrum, etc.) selected from the coordinator 107 provided list.

In another embodiment, the described procedure may also be implemented without a proxy computer system 102 at the established location 120, but rather by enabling the transportable transmitter 101 or transmitters 105 to communicate directly with the coordinator 107. The transportable transmitter 101 or transmitters 105 may then either incorporate the above described functions of the proxy 102 (e.g., but not limited to, adding all information needed to create a complete resource request) or depend upon functionality programmed into the coordinator 107 (e.g., but not limited to, identify the requestor e.g., 101 or 105 and retrieve missing information from a connected database 113).

In another embodiment, the coordinator 107 or proxy computer system 102 may add equipment information as the equipment is brought on-line. For example, the coordinator 107 or proxy computer system 102 may have existing records with necessary information and when a request for a geographically protected contour 104 may be received and the sender identified, any new or missing information in the request may be added to the current record. For example, the proxy 102 or coordinator 107 may automatically learn over time the complete inventory of transmitters 111, 105 and thereby simplify the management burden placed upon the transmitter's 100, 101 or proxy 102 operators.

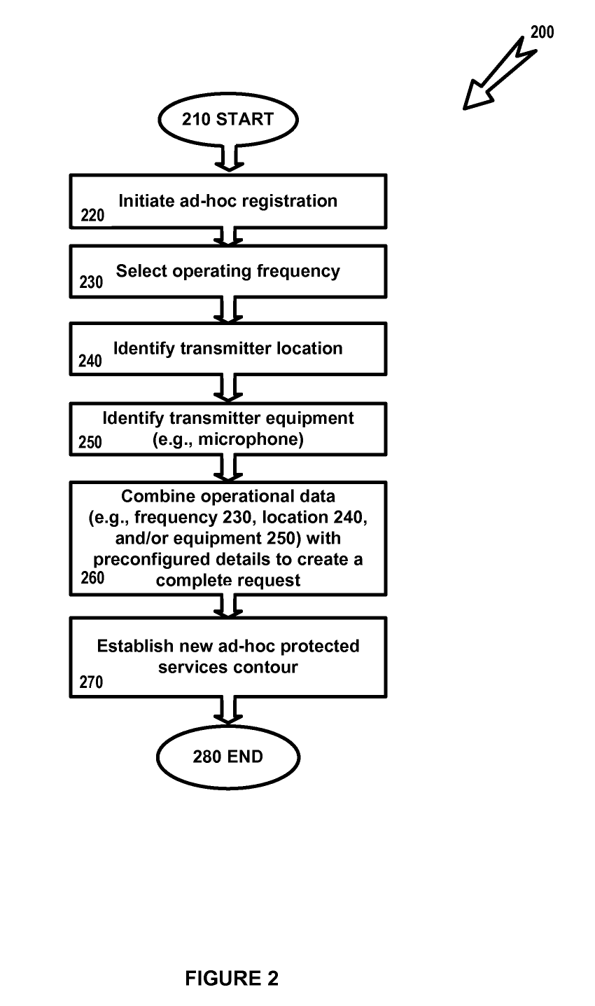

FIG. 2 illustrates an example high level operational flow chart 200 describing the steps to establish ad-hoc geographic service protection according to an exemplary embodiment. The order of the flow is shown for example only and may not necessarily flow in the order presented. Flow may begin at start 210 and proceed to initiate an ad-hoc registration 220. In 220, the portable wireless radiator base station 101 may begin the registration process to establish a new geographic protected services contour, e.g., 104. From 220, flow may proceed to selecting an operating frequency 230. From 230, flow may proceed to identifying the transmitter location 240. The transmitter location 240 may be, for example, a field reporting location 130. From 240, flow may proceed to identifying the wireless equipment or devices 250. The wireless equipment or devices may be, for example, one or more microphones, hospital devices, mobile phone, etc. From 250, flow may proceed to combining operational data (e.g., but not limited to, operating channel 230, transmitter location 240, and/or information on wireless equipment or devices 250) with preconfigured data to complete a complete reservation registration 260. From 260, flow may proceed to the establishment of a new ad-hoc protected services contour 270. The new contour 270 may be, for example, geographically protected contour 104. From 270, flow may terminate at end 280.

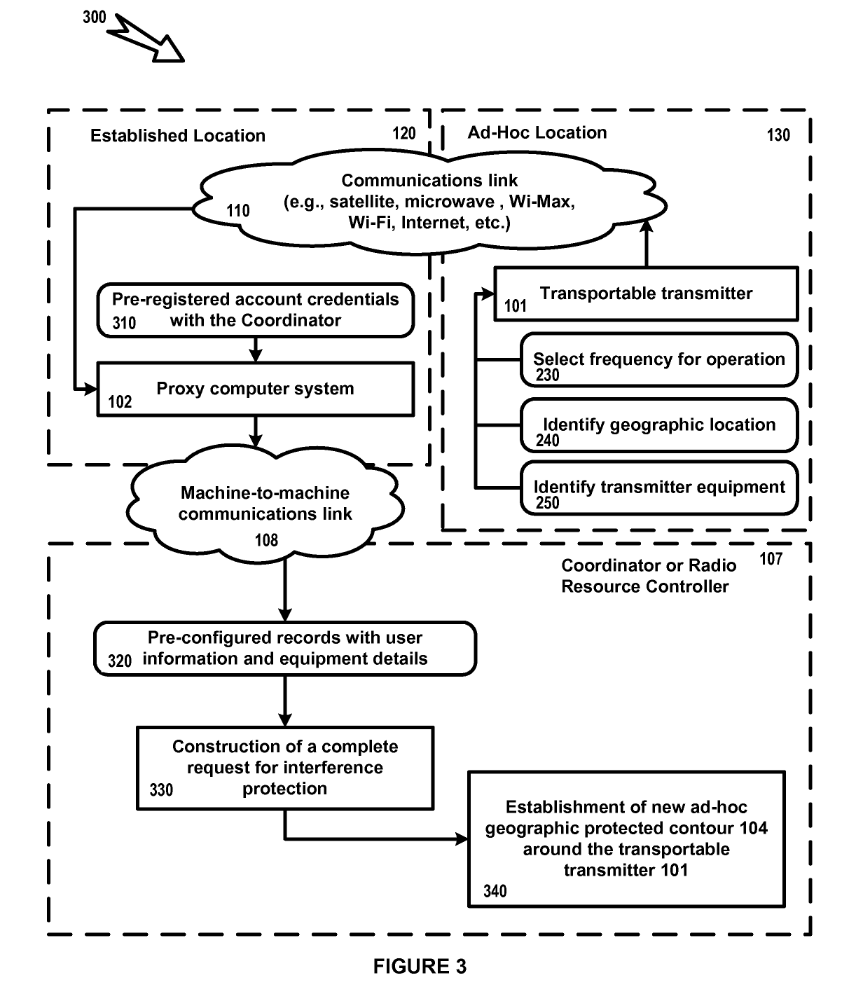

FIG. 3 depicts an example logical system chart 300 illustrating the types of information to be gathered and how that information may be assembled and exchanged from, for example, an ad hoc location 130 to a fixed location 120 and then to coordinator 107 to establish ad-hoc service protection, e.g., 104 according to an exemplary embodiment. The embodiment of FIG. 3 depicts information such as the frequency selected for operation 230, the geographic location 240, and the transmitter equipment 250 that may be associated with the transportable transmitter 101. Additional information may also be acquired. This information may then be sent over communications link 110, to, for example, the fixed broadcast station 120. The fixed broadcast station 120 may have pre-registered account credentials 310 with the coordinator 107. The pre-registered account credentials 310 may include, for example, digital cryptographic keys, contact information, equipment information, frequency information, etc. The proxy computer system 102 may then send data via communications link 108 to the coordinator 107. The coordinator may also have pre-configured records with user information and equipment details 320, as example. Using this information, the coordinator 107 may assemble a complete request for ad-hoc interference protection 330. From completing the request 330, flow may move to 340 where the establishment of an ad-hoc geographic protected contour 104 around the transportable transmitter 101 may be completed.

In an exemplary embodiment, the coordinator 107 may send an acknowledgement of a successful or failed request transaction. The coordinator 107 may also send an acknowledgement or confirmation of the establishment of a geographic protected contour 104. In yet another exemplary embodiment, the transportable transmitter 101 may request a list of available frequencies for use within an expected, hypothetical geographic protected contour 104 and the coordinator 107 may calculate and transmit the list of available frequencies to the transportable transmitter 101. In yet another embodiment, no frequency may be identified by the transportable transmitter 101, and the coordinator 107 may choose a frequency from a calculated list of available frequencies and may transmit the chosen frequency to the transportable transmitter 101.

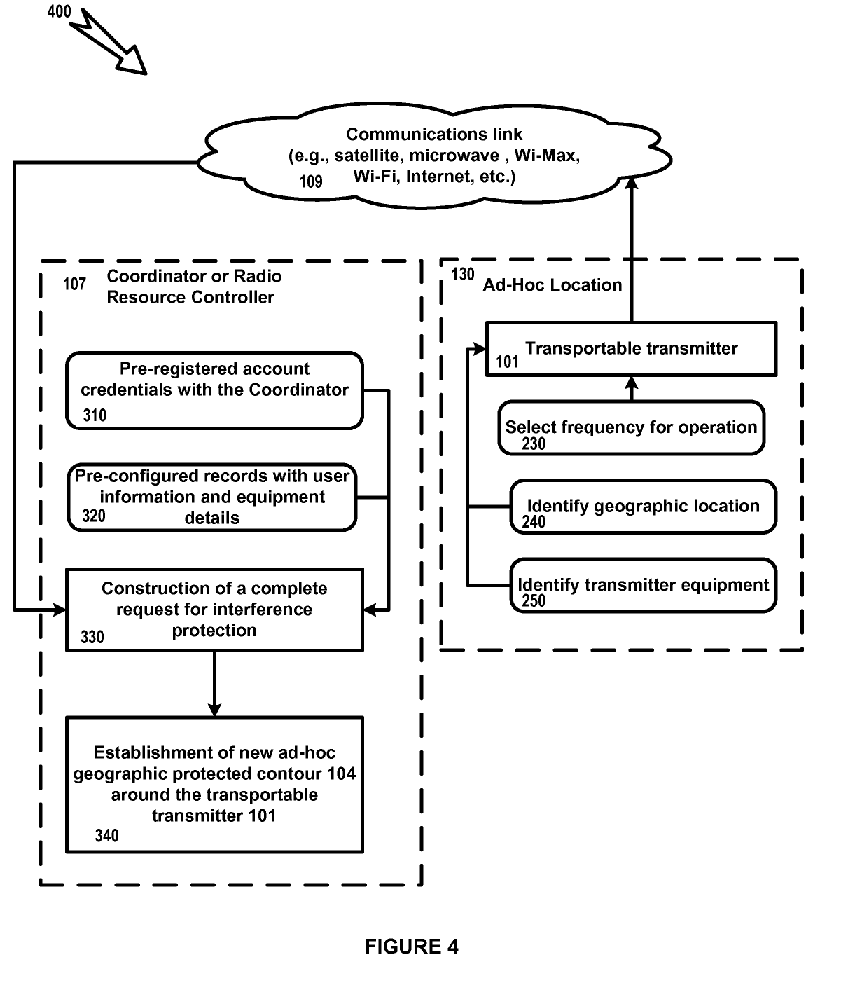

FIG. 4 depicts an example logical system chart 400 illustrating the types of information to be gathered and how that information may be assembled and exchanged from, for example, an ad-hoc location 130 directly to a coordinator 107 to establish an ad-hoc geographic protected contour for interference protection e.g., 104 according to an exemplary embodiment. The embodiment of FIG. 4 depicts information such as the frequency selected for operation 230, the geographic location 240, and the transmitter equipment 250, that may be associated with the transportable transmitter 101 or may be associated with transmitters 105. This information may be sent over a machine-to-machine communication link or network (e.g., but not limited to, satellite, microwave, Wi-Max, Wi-Fi, the Internet, etc.) 109 to the coordinator 107. The coordinator 107 may have pre-registered account credentials 310 and pre-configured records with other necessary information like user contact information and transmitter equipment details 320. The information from 310, 320, 230, 240, and 250 may be used to construct a complete request 330 for interference protection. From assembling a complete request 330, flow may move to 340 where an ad-hoc geographic protected contour 104 may be established around the transportable transmitter 101.

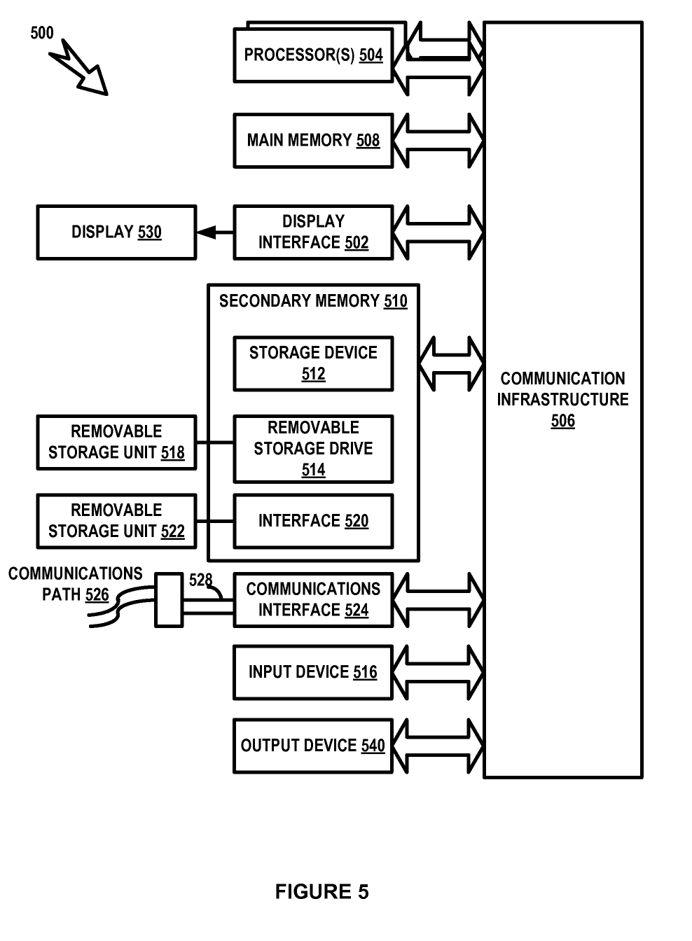

FIG. 5 depicts an exemplary embodiment of a computer system 500 that may be used in association with, in connection with, and/or in place of, e.g., but not limited to, any of the foregoing components and/or systems. One or more of the non-portable wireless radiator transportable transmitter 100, the portable wireless radiator transportable transmitter 101, proxy computer system 102, temporary wireless radiators 105, coordinator 107, the studio radiators 111, or web portal 112 may be implemented with a computer system 500.

The present embodiments (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 500 is shown in FIG. 5, depicting an exemplary embodiment of a block diagram of an exemplary computer system useful for implementing the present invention. Specifically, FIG. 5 illustrates an example computer 500, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/7/VISTA, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 5.

The computer system 500 may include one or more processors, such as, e.g., but not limited to, processor(s) 504. The processor(s) 504 may be connected to a communication infrastructure 506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 500 may include a display interface 502 that may forward, e.g., but not limited to, graphics, text, and other data, etc., from the communication infrastructure 506 (or from a frame buffer, etc., not shown) for display on the display unit 530.

The computer system 500 may also include, e.g., but may not be limited to, a main memory 508, random access memory (RAM), and a secondary memory 510, etc. The secondary memory 510 may include, for example, (but may not be limited to) a hard disk drive 512 and/or a removable storage drive 514, representing a floppy diskette drive, a magnetic tape drive, an optical disk drive, a magneto-optical disk drive, a compact disk drive CD-ROM, a digital versatile disk (DVD), a write once read many (WORM) device, a flash memory device, etc. The removable storage drive 514 may, e.g., but not limited to, read from and/or write to a removable storage unit 518 in a well known manner. Removable storage unit 518, also called a program storage device or a computer program product, may represent, e.g., but not limited to, a floppy disk, a magnetic tape, an optical disk, a magneto-optical disk, a compact disk, a flash memory device, etc. which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 522 and interfaces 520, which may allow software and data to be transferred from the removable storage unit 522 to computer system 500.

Computer 500 may also include an input device 516 such as, e.g., (but not limited to) a mouse or other pointing device such as a digitizer, a keyboard or other data entry device (none of which are labeled), and/or a touchscreen integrated with display 530, etc.

Computer 500 may also include output devices 540, such as, e.g., (but not limited to) display 530, and display interface 502. Computer 500 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Examples of communications interface 524 may include, e.g., but may not be limited to, a modem, a network interface (such as, e.g., an Ethernet card), a communications port, a Personal Computer Memory Card International Association (PCMCIA) slot and card, a transceiver, a global positioning system receiver, etc. Software and data transferred via communications interface 524 may be in the form of signals 528 which may be electronic, electromagnetic, optical or other signals capable of being received by communications interface 524. These signals 528 may be provided to communications interface 524 via, e.g., but not limited to, a communications path 526 (e.g., but not limited to, a channel). This channel 526 may carry signals 528, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 514, a hard disk installed in hard disk drive and/or other storage device 512, etc. These computer program products may provide software to computer system 500. The invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses and/or devices for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, an exemplary machine-readable storage medium may include, e.g., but not limited to, read only memory (ROM); random access memory (RAM); magnetic disk storage media; optical storage media; magneto-optical storage media; flash memory devices.

Computer programs (also called computer control logic), may include object oriented computer programs, and may be stored in main memory 508 and/or the secondary memory 510 and/or removable storage drive 514, removable storage unit 518, removable storage unit 522, also called computer program products. Such computer programs, when executed, may enable the computer system 500 to perform the features of the present invention as discussed herein. In particular, the computer programs, when executed, may enable the processor or processors 504 to provide a method to control and/or manage operation of a positioning effect detection device according to an exemplary embodiment of the present invention. Accordingly, such computer programs may represent controllers of the computer system 500.

In another exemplary embodiment, the invention may be directed to a computer program product comprising a computer readable medium having control logic (computer software) stored therein. The control logic, when executed by the processor 504, may cause the processor 504 to perform the functions of the invention as described herein. In another exemplary embodiment where the invention may be implemented using software, the software may be stored in a computer program product and loaded into computer system 500 using, e.g., but not limited to, removable storage drive 514, hard drive 512 or communications interface 524, etc. The control logic (software), when executed by the processor 504, may cause the processor 504 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

The exemplary embodiment of the present invention makes reference to, e.g., but not limited to, communications links, wired, and/or wireless networks. Wired networks may include any of a wide variety of well known means for coupling voice and data communications devices together. A brief discussion of various exemplary wireless network technologies that may be used to implement the embodiments of the present invention now are discussed. The examples are non-limiting. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB) networks, etc.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d, g, or n, such as, e.g., but not limited to, IEEE std. 802.11a, b, d, g and n (including, e.g., but not limited to IEEE 802.11g-2003, etc.), etc.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

According to an exemplary embodiment, exemplary methods set forth herein may be performed by an exemplary one or more computer processor(s) adapted to process program logic, which may be embodied on an exemplary computer accessible storage medium, which when such program logic is executed on the exemplary one or more processor(s) may perform such exemplary steps as set forth in the exemplary methods.

While various embodiments of the present invention have been described above, it should be understood that they have been presented by way of example only, and not limitation. Thus, the breadth and scope of the present invention should not be limited by any of the above-described illustrative embodiments, but should instead be defined only in accordance with the following claims and their equivalents

1. A computer-implemented method to reduce interference around wireless transmitters comprising:
generating a message to request a geographic protective contour by a requestor device having at least one processor;
transmitting the message from the requestor device via a network; and
transmitting within the geographic protective contour by the requestor device.

2. The method of claim 1, wherein the generating a message further comprises encrypting and authenticating the message.

3. The method of claim 1 further comprising:
collecting remote location operational data by the requestor device; and
inserting remote location operational data by the requestor device into the request for the geographic protected contour.

4. The method of claim 1, wherein the operational data comprises at least one of selected channel, geographic location of equipment, wireless equipment information, name of a party that maintains the equipment, time and duration of operation, at least one frequency to be used, contact information, or payment information.

5. The method of claim 1 further comprising:
receiving by the requestor device a first acknowledgement of a complete resource reservation request.

6. The method of claim 1 further comprising:
transmitting a preliminary request for available frequencies by the requestor device;
receiving a list of available frequencies by the requestor device;
selecting a frequency by the requestor device from the list of available frequencies; and
including the frequency selection by the requestor device into the request for the geographic protected contour.

7. The method of claim 1, wherein the transmitted message comprises an incomplete resource reservation message.

8. The method of claim 2, wherein encryption and authentication details of the authenticated and encrypted message are used for positively and automatically identifying the requestor device.

9. The method of claim 1, wherein necessary user information plus administrative and technical details are pre-configured in at least one of a proxy computer or a resource coordinator.

10. The method of claim 1, wherein transmitting the message further comprises:
transmitting from the requestor device to a resource coordinator via a proxy.

11. The method of claim 1, wherein transmitting the message further comprises:
transmitting from the requestor device directly to the radio resource coordinator.

12. The method of claim 1, further comprising:
receiving a message by the requestor device via the network containing a frequency selection for use within the geographic protected contour;
wherein the requestor device transmits using the frequency selection.

13. A system comprising:
one or more transmitters; and
a transportable transmitter having at least one processor and at least one storage device, the transportable transmitter configured to:
communicate with the one or more transmitters;
store operational data in the storage device;
encapsulate the operational data into a message;
transmit the message to establish a geographic protected contour for the transportable transmitter; and
after transmitting the message, transmit information on a transmitting frequency from within the geographic protected contour while receiving interference protection on the transmitting frequency within the geographic contour.

14. The system of claim 13, wherein the operational data comprises at least one of selected frequency, geographic location of equipment, wireless equipment information, name of a party that maintains the equipment, time and duration of operation, at least one frequency to be used, contact information, or payment information.

15. The system of claim 13, wherein the transportable transmitter is further configured to:
transmit the message from the transportable transmitter to a resource coordinator via a proxy.

16. The system of claim 13, wherein the transportable transmitter is further configured to:
transmit the message from the transportable transmitter directly to a resource coordinator.

17. A computer-readable medium comprising processor executable instructions for:
collecting remote location operational data by a transportable transmitter;
encapsulating the operational data into a message by the portable wireless transportable transmitter;
transmitting from the transportable transmitter the message to request a geographic protect contour for the portable wireless transportable transmitter;
receiving by the transportable transmitter at least one of:
a first acknowledgement of a complete resource reservation request for the geographic protected contour; or
a second acknowledgement of the establishment of the geographic protected contour.

18. The computer-readable medium of claim 17, wherein the operational data comprises at least one of selected channel, geographic location of equipment, wireless equipment information, name of a party that maintains the equipment, time and duration of operation, frequencies to be used, contact information, or payment information.

19. The computer-readable medium of claim 17, wherein transmitting the message further comprises:
transmitting from the transportable transmitter to a resource coordinator via a proxy.

20. The computer-readable medium of claim 17, wherein transmitting the message further comprises:
transmitting from the transportable transmitter directly to a resource coordinator.
